(19) United States
(12) Patent Application Publication
(10) Pub. No.: US 2026/0065256 A1
(43) Pub. Date: Mar. 5, 2026

(54) MICROPAYMENT PROCESSING METHOD

(71) Applicant: MASTERCARD INTERNATIONAL INCORPORATED, Purchase, NY (US)

(72) Inventors: Mohammed Sadiq Ahmad, Sacramento, CA (US); Maya Haylock, San Francisco, CA (US); Saravana Perumal Shanmugam, Fremont, CA (US)

(21) Appl. No.: 18/820,902

(22) Filed: Aug. 30, 2024

(51) Int. Cl. G06Q 20/22; G06Q 40/02

(52) U.S. Cl. CPC G06Q 20/29; G06Q 40/02

(57) ABSTRACT

A method is provided for processing micropayments. Micropayments are financial transactions involving relatively small financial amounts that can be difficult for conventional transaction processing systems to handle in a cost-effective and expeditious manner. The improved method uses a virtual micropayment account managed by a transaction processor. The limit of the virtual micropayment account may be adjusted with credit reduction requests and credit reset notices that are sent from the transaction processor to the issuer bank. The issuer bank may use the credit reduction requests and credit reset notices to adjust a temporary credit limit of the credit account from which the micropayments are to be made.

### BACKGROUND

The present inventions relate generally to financial transaction processing, and more particularly, to processing micropayment transactions.

Modern consumer payment systems commonly utilize sophisticated transaction systems involving one bank associated with the consumer, another bank associated with the merchant and a transaction processor that facilitates payments from the consumer bank to the merchant bank. While these systems are widely used, well-known and quite efficient, conventional transaction systems have costs associated with such systems that can be attributed to each individual transaction. In addition, each transaction through such a system takes a certain amount of time to be completed. In most situations, the individual transaction costs and processing time are minimal and do not cause any significant impediments to using such a system for ordinary purchases between consumers and merchants.

However, in some situations, transaction costs and processing time can become a concern for conventional modern consumer payment systems. One such situation involves micropayments between a consumer and a merchant. Although various monetary values can be used to define a micropayment, payments between a consumer and a merchant involving more than $10 are usually considered to be conventional payments and are not considered to be micropayments. That is, when the purchase price of a good or a service being sold to a consumer by a merchant is more than $10, the transaction costs associated with the transaction are minimal relative to the purchase price of the good or service, and therefore, the transaction costs raise few concerns for such purchases. On the other hand, when the purchase price is smaller (i.e., less than at least $10), the individualized cost of the transaction relative to the purchase price itself can be noticeably higher. This may limit the adoption of conventional modern consumer payment systems for such transactions.

Additionally, the amount of time that it takes to complete an individual transaction can be an impediment in some cases. Although conventional modern consumer payment systems are relatively fast in completing transactions, in some situations the consumer may have a greater need for transactions to be completed in real-time (i.e., nearly instantaneously). One example of this is computer gaming where the game allows purchases to be made while playing the game and where the purchase affects how the game is played. Not only is the speed of transaction processing critical for computer gaming with in-game purchases, but the value of such purchases is usually in the range of a micropayment. Thus, these types of transactions can be challenging for conventional modern consumer payment systems to complete efficiently and satisfactorily.

### SUMMARY

A method is described for processing micropayments more cost-effectively and quicker. In the method, a transaction processor receives micropayment requests from a merchant and approves the requests without sending the requests to the issuer bank. This is done by establishing a virtual micropayment account at the transaction processor. When a number of micropayment requests have been authorized by the transaction processor, the transaction processor accumulates the micropayment requests and submits a single payment approval request to the issuer bank. In order to offset the virtual micropayment account held by the transaction processor, the issuer bank reduces the credit limit of the consumer's credit account by the amount designated for the virtual micropayment account. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawing, in which:

FIG. 1 illustrates a schematic of a payment system showing card issuers, payment networks and acquirers;

FIG. 2 illustrates a schematic of a payment system showing a card issuer, payment network, acquirer, customer and merchant;

FIG. 3 illustrates a method of processing micropayments; and

FIG. 4 illustrates an example of a computer system that may implement the various features of FIGS. 1-3.

### DETAILED DESCRIPTION

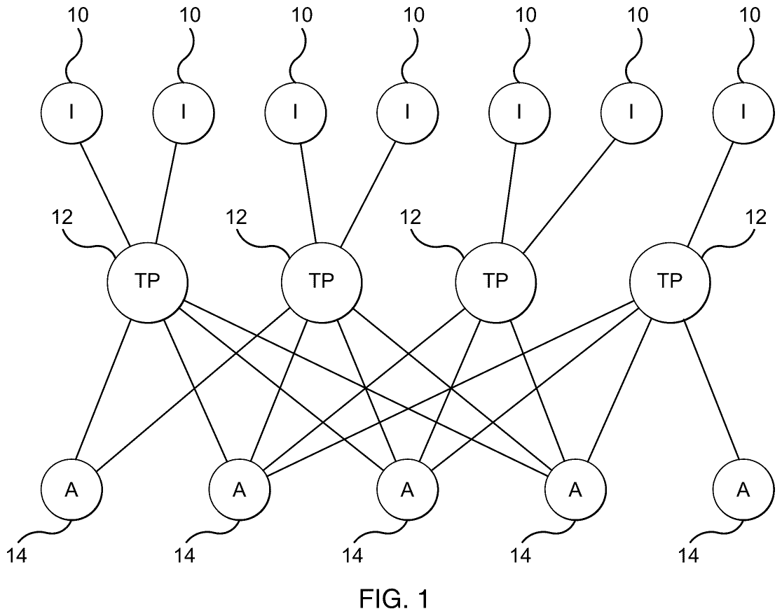

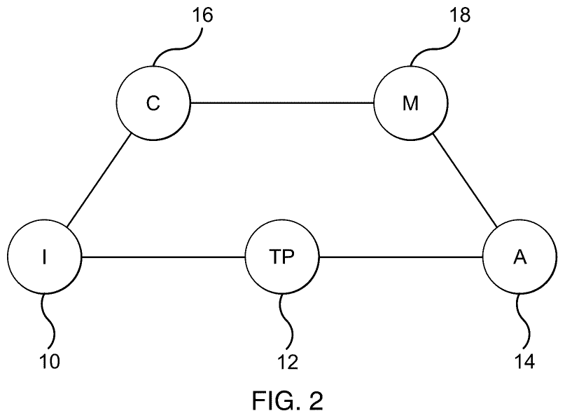

Referring now to the figures, and particularly FIG. 1, a schematic of a payment processing system is shown. As shown, the system typically involves three entities—card issuers 10, transaction processors 12 and acquirers 14 (in addition to consumers 16 and merchants 18, see FIG. 2). The transaction processors 12 are companies, such as MasterCard, Visa, Discover and American Express, that process financial transactions between the card issuers 10 and the acquirers 14. Typically, the card issuer 10 is associated with one of the transaction processors 12, and each of the transaction processors 12 are associated with multiple card issuers 10 who issue cards to consumers 16 that are associated with the particular transaction processor 12. However, it is understood that some card issuers 10 may issue cards to its consumers 16 from more than one of the transaction processors 12. Each of the acquirers 14 typically accept financial transactions processed through multiple transaction processors 12. However, it is possible for an acquirer 14 to choose to only process transactions from particular transaction processors 12 if desired. As explained below, some of the functions of the acquirer 14 may be performed by a separate third party payment processor, such as the backend kernel 26 described below. However, this possibility does not eliminate the acquirers 14 from the system since at a minimum financial funds are ultimately transferred from card issuers 10 to acquirers 14 to satisfy purchase payments between consumers 16 and the merchants 18. This also means that the acquirers 14 must be provided access by any such payment processors to payment data for their merchants 18 in order to manage financial receipts. Although FIG. 1 illustrates a limited number of card issuers 10 and acquirers 14, it is understood that the number of card issuers 10 and acquirers 14 in such a system typically measure in the thousands. By contrast, there are a relatively few number of transaction processors 12.

Turning to FIG. 2, a simpler schematic is shown which also includes consumers 16 and merchants 18. It is understood that a completed diagram like this would be impossible to show because the number of cardholders 16 (i.e., consumers 16) and merchants 18 can number in the millions. Even so, it can be seen that in a typical credit card processing system that the consumer 16 primarily interacts with the card issuer 10 and a merchant 18. That is, the cardholder 16 keeps a credit or debit card account with the card issuer 10 and traditionally retains a physical credit or debit card which was issued by the card issuer 10 that the consumer 16 then uses to authorize various financial transactions. The underlying financial transactions are initiated by the consumer 16 by purchasing goods or services from a merchant 18 and authorizing payment for the goods or services using the credit or debit card issued by the card issuer 10. The card issuer 10 later issues a statement to the consumer 16 and receives payment from the consumer 16 to cover the financial transactions authorized by the consumer 16.

The merchant 18 principally interacts with an acquirer 14, in addition to interacting with the consumer 16 to sell the goods or services. Once the purchase is complete, the merchant 18 provides the purchase details to the acquirer 14, including at least the financial amount of the transaction and the credit card number used by the consumer 16 to authorize the purchase. The acquirer 14 then submits the financial transaction to the transaction processor 12 associated with the credit or debit card used by the consumer 16. The transaction processor 12 then processes the financial transaction and facilitates the transfer of financial funds from the card issuer 10 to the acquirer 14 to satisfy the financial transaction. It is understood that in such a system with millions of consumers 16 and merchants 18 and thousands of card issuers 10 and acquirers 14 that the system must be able to process millions of financial transactions on a constant basis and that such credit card processing can only be accomplished using automated computer systems usually involving computer servers employing multiple computer processors and computer memory storing the computer instructions which cause the processors to automatically process millions of financial transactions.

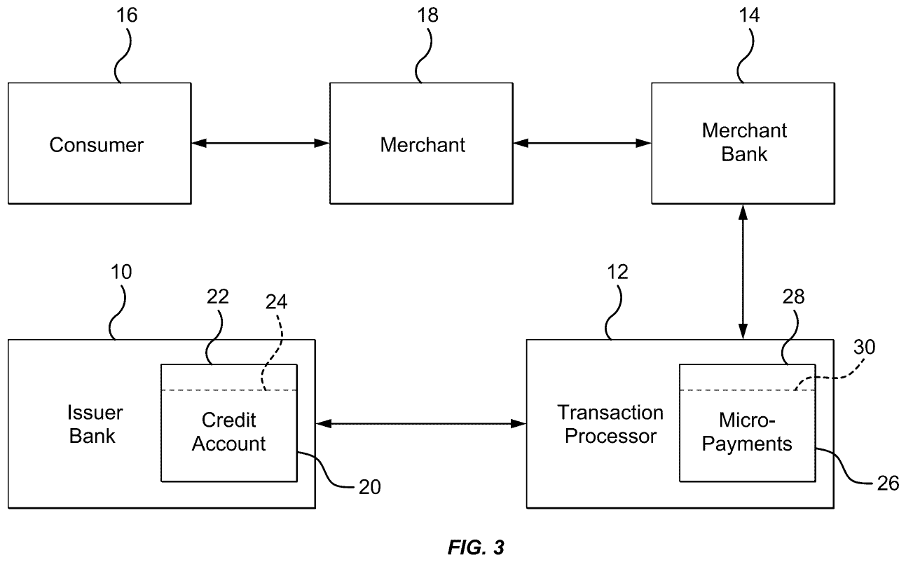

Turning to FIG. 3, a method of processing micropayments is shown. As shown, the method preferably involves a consumer 16, a merchant 18, a merchant bank 14 (also referred to as an acquirer 14), a transaction processor 12 and an issuer bank 10 (also referred to as a card issuer 10). As is generally understood, the consumer 16 initiates a purchase at the merchant 18 by selecting a product or service that the consumer 16 wishes to purchase and provides the merchant 18 with an identification of a credit account 20 (e.g., a credit card number) from which the purchase price will be paid. It is understood that additional information may be required from the consumer 16, such as a CVV number from a credit card and an authorization signature by the consumer 16. In the present inventions, it is preferred for the credit account 20 information to be tokenized for secure transmission and that the consumer signature be a cryptographic signature. It is understood that the interaction between the consumer 16 and the merchant 18 may occur in person in a brick and mortar store, over the phone or online.

Typically, the merchant 18 sends the purchase request information and the credit account 20 information to a bank 14 that is associated with the merchant 18 at which the payment will be made to satisfy the purchase. The merchant bank 14 then forwards the purchase request information and the credit account 20 information to a transaction processor 12 on behalf of the merchant 18. The transaction processor 12 then sends the purchase request information and the credit account 20 information to the issuer bank 10 which holds and maintains the credit account 20. When the issuer bank 10 approves the financial transaction, the financial amount of the purchase price which was agreed to between the consumer 16 and the merchant 18 is transferred from the issuer bank 10 to the merchant bank 14 to satisfy payment to the merchant 18.

Although the present inventions utilize steps of conventional financial transaction processing as generally described above, the present inventions are directed to improvements in processing micropayments. Thus, the present inventions are particularly useful for transactions where each purchase price is $5 or less or $2 or less. The present inventions are also particularly useful where the consumer 16 initiates multiple micropayments within a relatively short period of time (e.g., on the same day). This may occur, for example, when a consumer 16 is playing a computer game with in-game purchases or when the consumer 16 is purchasing multiple smaller items like music songs, etc. In such cases, conventional credit card processing steps may be insufficient due to the transactional costs associated with each purchase and the time delays associated with receiving approvals from the issuer bank 10.

In the present inventions, one or more merchants 18 receive purchase requests for small financial amounts (e.g., $5 or $2 or less) from the consumer 16 along with credit account 20 information (e.g., credit card details) to complete the purchases. The merchants 18 then send micropayment requests to a transaction processor 12. Typically, the micropayment requests may be sent by the merchant 18 to the transaction processor 12 through the merchants'banks 14. In some embodiments, the micropayment requests that are sent to the transaction processor 12 are not identified as micropayments by the merchants 18, but instead, are characterized as such by the transaction processor 12 based on the value of the payment request being below a previously specified and/or agreed to amount (e.g., $5 or less, $2 or less, etc.). Alternatively, the merchants 18 may send a micropayment identifier to the transaction processor 12 with the payment requests which informs the transaction processor 12 that the payment requests are micropayment requests and are to be treated differently from conventional payment requests since the payment request involves a micropayment. It is also possible for individual merchants 18 to be labeled by the transaction processor 12 as micropayment merchants 18 so that payment requests from such merchants 18 are treated as micropayment requests by default.

Unlike conventional payment requests which are sent to the issuer bank 10 over a payment network for approval before approval notices are sent to the merchants 18, the transaction processor 12 can locally review and determine whether to approve the micropayment requests. Thus, transaction processor 12 can make micropayment approval decisions without sending, potentially multiple and successive, micropayment requests to the issuer bank 10 (which in gaming and some other scenarios can occur in a relatively short amount of time). As such, local processing by transaction processor 12 reduces network traffic (thereby conserving network resources, such as, network bandwidth, network interface, system memory, and processor) and facilitates more efficient micropayment approval decisions Local processing also reduces time to approval decisions since review by the issuer bank 10 often takes relatively (and potentially significantly) more time in conventional transaction processing. Any possibility of a later conflict with the issuer bank 10 in regards to the approval of micropayment requests is mitigated by the transaction processor 12 sending appropriate credit reduction requests to the issuer bank 10.

When the issuer bank 10 receives the credit reduction request, the issuer bank 10 reduces the normal credit limit 22 assigned to the consumer's credit account 20 to a new temporary reduced credit limit 24. This allows the transaction processor 12 to establish a virtual micropayment account 26 under the direct control of the transaction processor 12 with a micropayment limit 28 in an amount corresponding to the credit reduction request. Preferably, the issuer bank 10 sends a notification back to the transaction processor 12 when the credit limit 22 of the consumer's credit account 20 has been reduced in response to the credit reduction request. Where the issuer bank 10 sends a confirmation notification to the transaction processor 12, the transaction processor 12 may use the notification as a basis for sending one or more (micropayment) approval notices to the merchant 18 without specific payment request approvals from the issuer bank 10 (and any corresponding network traffic). The credit reduction request can be for a financial amount that is more than at least two different expected micropayment requests. Thus, for example, where a micropayment is considered to be a financial amount of $2 or less, the credit reduction request could be for a financial amount of as little as $10.

Generally, it is expected that the credit reduction request will be for a relatively small amount so that the consumer's credit limit 22 is not significantly changed in a way that would substantially reduce the consumer's purchasing power for non-micropayment purchases. Thus, it may be appropriate for the amount of the credit reduction request and the limit of the virtual micropayment account 26 to be no more than $50. The transaction processor 12 may send credit reduction requests to the issuer bank 10 at various points of time. For example, the transaction processor 12 may send a credit reduction request the first time that the transaction processor 12 receives a micropayment request from a merchant 18 for a particular consumer 16. The transaction processor 12 may also send multiple credit reduction requests over time based on the consumer's 16 purchasing activity. The transaction processor 12 may also establish a virtual micropayment account 26 for a consumer 16 by sending a credit reduction request to the issuer bank 10 when a consumer 16 requests that such a service be added to the consumer's 16 credit account 20.

Once the virtual micropayment account 26 has been established by the transaction processor 12, each micropayment request may be locally approved by the transaction processor 12 by sending approval notices to the merchant 18 (e.g., the merchant's bank 14) and without sending the request to the issuer bank 10 for review. Preferably, the transaction processor 12 sends approval notices to the merchant 18 sequentially as they are received sequentially from the merchant 18 to ensure the quickest turnaround time possible. If a micropayment identifier is used, the transaction processor 12 may also use the micropayment identifier as a basis for sending approval notices to the merchant 18 without sending the request to the issuer bank 10 for review. Such approval notices may continue to be sent to the merchant 18 as long as the total 30 of all micropayment requests that have been approved by the transaction processor 12 without sending the payment requests to the issuer bank 10 is less than the limit 28 of the virtual micropayment account 26 (i.e., less than the total of the credit reduction requests sent to the issuer bank 10 offset by any credit reset notices). At a later point in time, the transaction processor 12 then accumulates multiple micropayment requests that have been approved by the transaction processor 12 but which have not been sent to and approved by the issuer bank 10. Preferably, the micropayment requests are accumulated together for requests from individual merchants 18, but it may also be possible for multiple micropayment requests to be accumulated together for different merchants 18. The accumulated micropayment requests are then sent to the issuer bank 10 as a single approval request for all of the accumulated micropayment requests together. As a result, transaction costs may be reduced since the issuer bank 10 reviews and approves a single payment request instead of multiple payment requests.

The transaction processor 12 also sends a credit reset notice to the issuer bank 10, which is preferably sent at the same time with the single accumulated payment request. In response to the credit reset notice, the issuer bank 10 increases the temporary credit limit 24 of the consumer's 16 credit account 20 by the amount of the credit reset notice, and the transaction processor 12 lowers the limit 28 of the virtual micropayment account 26 by the amount of the credit reset notice. The financial amount of the credit reset notice should typically be the same as or more than the single accumulated payment request. For example, if the credit reset notice is for an amount that is equal to the original credit reduction request (without intervening credit reduction requests), the credit reset notice effectively closes the virtual micropayment account 26 with the transaction processor 12 and returns the consumer's credit account 20 temporary limit 24 back to its default limit 22. In this arrangement, it may be desirable for a time limit to be set on how long the virtual micropayment account 26 will remain active. For example, a time limit of 24 hours may be set between when the credit reduction request is sent and when the credit reset notice is sent. Thus, in one embodiment, the virtual micropayment account 26 may be temporary and remains active only for a set time period (e.g., 24 hours). Alternatively, the virtual micropayment account 26 may be utilized as a revolving virtual account 26. For example, the credit reset notice may be for an amount that is equal to all of the micropayment requests that have been approved by the transaction processor 12 without having been previously sent individually to the issuer bank 10. In this case, the credit reset notice will be for an amount that is less than the limit 28 of the virtual micropayment account 26 which may leave the virtual micropayment account 26 active. If it is desirable to keep the virtual micropayment account 26 active, the transaction processor 12 may then send another credit reduction request to the issuer bank 10 to raise the limit 28 of the virtual micropayment account 26 again (e.g., by the amount of the single accumulated payment request and the credit reset notice so that the limit 28 of the virtual micropayment account 26 is effectively reset).

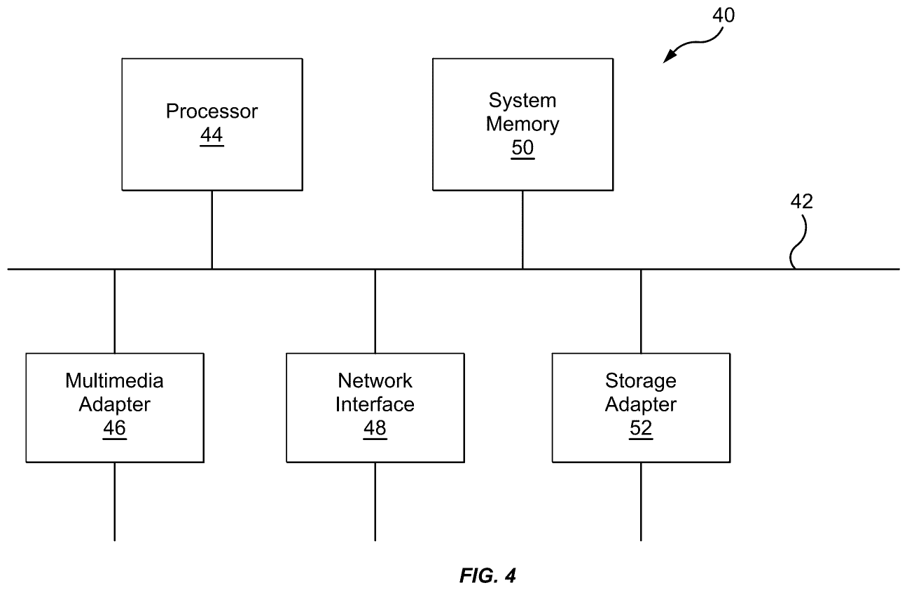

FIG. 4 illustrates an example of a computer system 40 that may implement the various features of FIGS. 1-3. The computer system 40 may be part of or include the transaction processor 12, merchant 18, 14, issuer bank 10 to perform the functions and features described herein. For example, various ones of the devices used in the described system may be implemented based on some or all of the computer system 40.

The computer system 40 may include, among other things, an interconnect 42, a processor 44, a multimedia adapter 46, a network interface 48, a system memory 50, and a storage adapter 52. The interconnect 42 may interconnect various subsystems, elements, and/or components of the computer system 40. As shown, the interconnect 42 may be an abstraction that may represent any one or more separate physical buses, point-to-point connections, or both, connected by appropriate bridges, adapters, or controllers. In some examples, the interconnect 42 may include a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1364 bus, or “firewire,” or other similar interconnection element.

In some examples, the interconnect 42 may allow data communication between the processor 44 and system memory 50, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 44 may control operations of the computer system 40. In some examples, the processor 44 may do so by executing instructions such as software or firmware stored in system memory 50 or other data via the storage adapter 52. In some examples, the processor 44 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 46 may connect to various multimedia elements or peripherals. These may include devices associated with visual (e.g., video card or display), audio (e.g., sound card or speakers), and/or various input/output interfaces (e.g., mouse, keyboard, touchscreen). The network interface 48 may provide the computer system 40 with an ability to communicate with a variety of remote devices over a network. The network interface 48 may include, for example, an Ethernet adapter, a Fibre Channel adapter, and/or other wired- or wireless-enabled adapter. The network interface 48 may provide a direct or indirect connection from one network element to another and facilitate communication and between various network elements. The storage adapter 52 may connect to a standard computer readable medium for storage and/or retrieval of information, such as a fixed disk drive (internal or external).

Other devices, components, elements, or subsystems (not illustrated) may be connected in a similar manner to the interconnect 42 or via a network. The devices and subsystems can be interconnected in different ways from that shown in FIG. 4. Instructions to implement various examples and implementations described herein may be stored in computer-readable storage media such as one or more of system memory 50 or other storage. Instructions to implement the present disclosure may also be received via one or more interfaces and stored in memory. The operating system provided on computer system 40 may be MS-DOS®, MS-WINDOWS®, OS/2®, OS X®, IOS®, ANDROID®, UNIX®, Linux®, or another operating system.

The components of the system illustrated in FIGS. 1-3 may be connected to one another via a communication network (not illustrated), which may include the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network through which system components may communicate.

The datastores described herein may be, include, or interface to, for example, an Oracle™ relational database sold commercially by Oracle Corporation. Other databases, such as PROMETHEUS, INFLUX DB, MYSQL, Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

It is understood that the described micropayment processing method is intended to operate autonomously on programmed computer systems utilizing computer algorithms such that the system may be implemented by one or more computer processors (e.g., in a server system) executing computer-executable instructions stored on a non-transitory computer-readable storage medium. Thus, for example, in the case of the transaction processor 12, merchant 18, 14, issuer bank 10 and other steps described herein, it is unnecessary for human beings to make the required data transmissions, determinations, etc. That is, other than the typical personal interactions that occur between the consumer 16 and the merchant 18 when in person purchases are made, all of the remaining steps of the process may be performed autonomously by programmed computer systems. This autonomous design makes the micropayment processing method scalable to a level that would be impractical if human beings were to attempt to perform the steps required by the method. While it is understood that various human beings may provide inputs to the system and may adjust parameters that control how the system operates, the micropayment processing method is intended to have the capability of processing many thousands of micropayments in short periods of time (e.g., seconds or less) that would be impossible to accomplish with human intervention in each transaction. However, because such computerized systems are very expensive to set up and maintain, it is important for the method steps to be designed in the most efficient way possible to reduce equipment costs and increase transactional throughput of the computerized system.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A method of processing micropayments, comprising:
a first merchant receiving from a consumer a first purchase request for a first financial amount and receiving an identification from the consumer of a credit account with an issuer bank from which the first financial amount is to be paid to the first merchant;
the first merchant sending a first micropayment request to a transaction processor for the first financial amount;
the transaction processor sending a credit reduction request to the issuer bank for a second financial amount, the second financial amount being larger than the first financial amount;
the issuer bank reducing a credit limit associated with the credit account by the second financial amount in response to the credit reduction request;
the transaction processor sending an approval notice to the first merchant approving the first micropayment request without sending the first micropayment request to the issuer bank for approval;
the second merchant receiving a second purchase request from the consumer, the second purchase request being for a third financial amount and identifying the credit account with the issuer bank from which the third financial amount is to be paid to the second merchant;
the second merchant sending a second micropayment request to the transaction processor for the third financial amount;
the transaction processor sending an approval notice to the second merchant approving the second micropayment request without sending the second micropayment request to the issuer bank for approval if a total of the first financial amount and the third financial amount is less than the second financial amount;
the transaction processor sending a single approval request to the issuer bank for the first micropayment request and the second micropayment request and sending a credit reset notice to the issuer bank for a fourth financial amount, the fourth financial amount being at least as much as the total of the first financial amount and the third financial amount; and
the issuer bank resetting the credit limit associated with the credit account by the fourth financial amount in response to the credit reset request.

2. The method of processing micropayments according to claim 1, wherein a time period between the transaction processor sending the credit reduction request to the issuer bank and the transaction processor sending the credit reset notice to the issuer bank is less than 24 hours.

3. The method of processing micropayments according to claim 1, wherein the transaction processor sends the single approval request and the credit reset notice to the issuer bank at the same time.

4. The method of processing micropayments according to claim 1, wherein the first amount and the third financial amounts are each $5 or less.

5. The method of processing micropayments according to claim 1, wherein the first financial amount and the third financial amounts are each $2 or less.

6. The method of processing micropayments according to claim 1, wherein the second financial amount is $50 or less.

7. The method of processing micropayments according to claim 1, wherein the second financial amount and the fourth financial amount are equal to each other.

8. The method of processing micropayments according to claim 1, wherein the fourth financial amount is equal to all first and third financial amounts for which the transaction processor has sent approval notices to the first and second merchants without sending the first and second micropayment requests to the issuer bank for approval.

9. The method of processing micropayments according to claim 1, wherein the transaction processor sends the credit reduction request to the issuer bank in response to the first micropayment request.

10. The method of processing micropayments according to claim 1, wherein the issuer bank sends a notification to the transaction processor that the credit limit of the credit account has been reduced by the second financial amount.

11. The method of processing micropayments according to claim 10, wherein the transaction processor sends the approval notice to the first merchant approving the first micropayment request in response to the notification from the issuer bank.

12. The method of processing micropayments according to claim 1, wherein the second merchant sends a plurality of the second micropayment requests to the transaction processor sequentially as a plurality of the second purchase requests are received by the second merchant, and the transaction processor sends the approval notices to the second merchant approving the second micropayment requests sequentially as the second micropayment requests are received by the transaction processor.

13. The method of processing micropayments according to claim 1, wherein the identification of the credit account is tokenized and sent to the transaction processor with a cryptographic signature.

14. The method of processing micropayments according to claim 1, wherein the first and second merchants send each of the first and second micropayment requests to the transaction processor with a micropayment identifier, the transaction processor approving the first and second micropayment requests without sending the first and second micropayment requests to the issuer bank for approval based on the micropayment identifier.

15. The method of processing micropayments according to claim 1, wherein the first and second merchants are different from each other.

16. The method of processing micropayments according to claim 1, wherein the first and second merchants are the same merchant.

17. The method of processing micropayments according to claim 1, wherein a merchant bank sends the first and second micropayment requests to the transaction processor and receives the approval notices from the transaction processor on behalf of the merchant.

18. The method of processing micropayments according to claim 1, wherein the transaction processor sends the single approval request and the credit reset notice to the issuer bank at the same time, the first financial amount and the third financial amounts are each $2 or less, and the second financial amount is $50 or less.

19. The method of processing micropayments according to claim 18, wherein the issuer bank sends a notification to the transaction processor that the credit limit of the credit account has been reduced by the second financial amount.

20. The method of processing micropayments according to claim 19, wherein the first and second merchants send each of the first and second micropayment requests to the transaction processor with a micropayment identifier, the transaction processor approving the first and second micropayment requests without sending the first and second micropayment requests to the issuer bank for approval based on the micropayment identifier.
